(19) United States
(12) Patent Application Publication
(10) Pub. No.: US 2025/0025955 A1
(43) Pub. Date: Jan. 23, 2025

(54) WELDING QUALITY INSPECTION APPARATUS AND A METHOD FOR THE SAME

(71) Applicants: HYUNDAI MOTOR COMPANY, Seoul (KR); KIA CORPORATION, Seoul (KR); eZRobotics Co., Ltd., Suwon-si (KR)

(72) Inventors: Beomjun Kim, Anyang-si (KR); Seung Ho Lee, Incheon (KR); Yubin Jeon, Incheon (KR); Taehan Heo, Suwon-si (KR); Choongho Nam, Suwon-si (KR); Jungmin Kim, Suwon-si (KR)

(73) Assignees: HYUNDAI MOTOR COMPANY, Seoul (KR); KIA CORPORATION, Seoul (KR); eZRobotics Co., Ltd., Suwon-si (KR)

(21) Appl. No.: 18/511,225

(22) Filed: Nov. 16, 2023

(30) Foreign Application Priority Data
Jul. 18, 2023 (KR) 10-2023-0092788

(51) Int. Cl. B23K 9/095

(52) U.S. Cl. CPC B23K 9/0956

(57) ABSTRACT

A welding quality inspection apparatus includes: a welding position calculation part calculating a first virtual welding position based on an actual welding position of a robot welding gun; a comparison and verification part calculating a first error by comparing the first virtual welding position and a reference welding position, and determining that inspection is necessary when a magnitude of the first error is within a reference range; a calibration part, when a ratio of determining that inspection is necessary, by the comparison and verification part, is a preset criterion or more, generating a second virtual welding position based on the first virtual welding position by repeating calibration until the ratio of determining that inspection is necessary becomes less than the preset criterion; and a compensation part extracting a second error between the second virtual welding position and the reference welding position and compensating.

### CROSS-REFERENCE TO RELATED APPLICATION

This application claims priority to and the benefit of Korean Patent Application No. 10-2023-0092788, filed on Jul. 18, 2023, the entire contents of which are incorporated herein by reference.

### BACKGROUND

### (a) Field of the Disclosure

The present disclosure relates to a welding quality inspection apparatus and a method for the same. More particularly, the present disclosure relates to a welding quality inspection apparatus and a method capable of inspecting welding position defects and welding omissions.

### (b) Description of the Related Art

Welding is a matter directly related to vehicle safety issues, and an accurate confirmation procedure is required. When quality defects such as welding position defects and welding omissions occur, problems directly related to vehicle safety such as injury to occupants due to deterioration of vehicle body strength, noise problems while driving, and water tightness problems during heavy rain may occur. As a result, securing reliability in welding quality is a very important quality factor that vehicle manufacturers must secure.

However, there is currently no clear automatic inspection method for welding quality in body factories, so over 7,500 welding points are inspected by manual visual inspection. Accordingly, vehicles with defective welding quality due to human errors may be sold and supplied to customers.

In order to prevent welding omissions, a welding omission prevention inspection is performed by counting the welding points performed by the robot. However, it is not possible to confirm whether welding is performed at the correct locations and whether there are no real welding omissions.

In the case of vision inspection conducted to prevent welding location defects and omissions, vision inspection equipment must be installed in the vehicle body factory to perform the inspection, and it is not applicable if there is no such equipment. In addition, due to the nature of the line/equipment, all welding points cannot be inspected at once. Furthermore, in the case of vision inspection, if a closed structure or welding point is covered by another component, an inspection may not be possible, as expected in the case of a camera. Welding is a process of combining different parts, and during vision inspection in the process of manufacturing a vehicle body, situations may occur in which welding points are covered or cannot be confirmed.

When inspecting the welding quality by vision inspection, it is necessary to teach the vision robot a standard (i.e., setting the reference position of a welding point inspection of the robot). If the reference point teaching is unstable, the reliability of the quality inspection of the welding position deteriorates. In addition, it is practically impossible to measure a large number of welding points within the process production time (cycle time). Therefore, there is a problem in that a large amount of vision inspection equipment is required in order to inspect all welding points exceeding 7,500 points within a processing time.

The above information disclosed in this Background section is only to enhance understanding of the background of the disclosure. Therefore, the Background section may contain information that does not form the prior art that is already known to a person of ordinary skill in the art.

### SUMMARY

The present disclosure provides a welding quality inspection apparatus and method capable of comparing, verifying, and compensating positions of the welding points of a drawing and positions of actual welding points. This is achieved by uploading big data of the actual coordinates of a robot welding gun to a virtual space program.

A welding quality inspection apparatus may include a welding position calculation part configured to calculate a first virtual welding position based on an actual welding position of a robot welding gun. The apparatus may also include a comparison and verification part configured to calculate a first error by comparing the first virtual welding position and a reference welding position of the drawing, and to determine that inspection is necessary when a magnitude of the first error is within a reference range. The apparatus may also include a calibration part configured to, when a ratio of determining that inspection is necessary, by the comparison and verification part, is a preset criterion or more, generate a second virtual welding position based on the first virtual welding position by repeating calibration until the ratio of determining that inspection is necessary becomes less than the preset criterion. The apparatus may also include a compensation part configured to extract a second error between the second virtual welding position and the reference welding position when the calibration is finished, and to compensate the second error when the second error is a predetermined reference value or more.

The reference welding position, the first virtual welding position, and the second virtual welding position may be calculated as 3-dimensional coordinates.

The calibration part may be configured to perform calibration in which a conversion matrix for compensation of the first error is generated. The first virtual welding position is compensated by using the conversion matrix.

The conversion matrix may be calculated by comparing the first virtual welding position and the reference welding position. The first virtual welding position and the reference welding position are expressed as vectors.

The comparison and verification part may be configured to determine the first virtual welding position to be normal when the magnitude of the first error is smaller than the reference range. The comparison and verification part may also be configured to determine the first virtual welding position to be defective when the magnitude of the first error is greater than the reference range.

The compensation part may compensate the first virtual welding position determined to be defective to match the reference welding position.

The reference range may be 5 mm to 10 mm.

The preset criterion may be 80%.

The predetermined reference value may be 5 mm.

The compensation part may be configured to extract the 3-dimensional coordinates of each of the second virtual welding position and the reference welding position to calculate the second error. The compensation part may also be configured to modify a robot program of the robot welding gun with the second error to compensate the actual welding position of the robot welding gun.

The compensation part may be configured to send a first alarm message regarding a welding position's defects when the compensation is determined to be required. The compensation part may also be configured to send a second alarm message notifying that the welding position has been changed when the compensation is completed.

A welding quality inspection method may include calculating, by a welding quality inspection apparatus, a first virtual welding position by uploading a coordinate of a robot welding gun with respect to an actual welding position to the welding quality inspection apparatus. The method may also include performing comparison and verification, by the welding quality inspection apparatus, where a first error may be calculated by comparing the first virtual welding position and a reference welding position of the drawing, and determining that inspection is necessary when a magnitude of the first error is within a reference range. The method may also include performing calibration, where, when a ratio of determining that inspection is necessary is a preset criterion or more, generate a second virtual welding position based on the first virtual welding position that is generated by repeating calibration until the ratio of determining that inspection is necessary becomes less than the preset criterion.

The performing calibration may include generating a conversion matrix for compensation of the first error, and compensating the first virtual welding position by using the conversion matrix.

The conversion matrix may be calculated by comparing 3-dimensional coordinate values of the first virtual welding position and the reference welding position.

A welding quality inspection method may further include extracting a second error between the second virtual welding position and the reference welding position when the calibration is finished. Additionally, the method may include compensating the second error when the second error is a predetermined reference value or more.

The performing comparison and verification may include determining the first virtual welding position to be normal when the magnitude of the first error is smaller than the reference range. The performing comparison and verification may also include determining the first virtual welding position to be defective when the magnitude of the first error is greater than the reference range.

The compensating the second error may include compensating the first virtual welding position determined to be defective, to match the reference welding position.

The compensating the second error may further include extracting the coordinate of each of the second virtual welding position and the reference welding position, to calculate the second error. The compensating the second error may also include modifying a robot program of the robot welding gun with the second error, to compensate the actual welding position of the robot welding gun.

The reference range may be 5 mm to 10 mm.

The preset criterion may be 80%.

A welding quality inspection apparatus and method according to an embodiment may compare, verify, and compensate positions of the welding points of a drawing and positions of actual welding points. This may be achieved by uploading big data of actual coordinates of a robot welding gun to a virtual space program.

A welding quality inspection apparatus and method according to an embodiment may prevent welding omission/separation by confirming correct welding positions.

### BRIEF DESCRIPTION OF THE DRAWINGS

These drawings are for reference only in describing embodiments of the present disclosure. Therefore, the technical idea of the present disclosure should not be limited to the accompanying drawings.

FIG. 1 is a drawing showing a welding quality inspection system according to an embodiment.

FIG. 2 is a block diagram of a welding quality inspection apparatus according to an embodiment.

FIG. 3 is a flowchart of a welding quality inspection method according to an embodiment.

FIG. 4 is a drawing showing a calibration step according to an embodiment.

FIG. 5 is a drawing showing a comparison and verification step according to an embodiment.

FIG. 6 is a drawing showing a calibration step according to an embodiment.

FIG. 7 shows a conversion matrix according to an embodiment.

FIG. 8 is a flowchart of a welding quality inspection method according to an embodiment.

FIG. 9 is a drawing explaining a computing device according to an embodiment.

### DETAILED DESCRIPTION

An embodiment of the disclosure will be described fully hereinafter with reference to the accompanying drawings such that a person having ordinary skill in the art may easily implement the embodiment. As those having ordinary skill in the art would realize, the described embodiments may be modified in various different ways, all without departing from the spirit or scope of the present disclosure. In order to clarify the present disclosure, parts that are not related to the description will be omitted, and the same elements or equivalents are referred to with the same reference numerals throughout the specification.

In addition, unless explicitly described to the contrary, the word “comprise” and variations such as “comprises” or “comprising” will be understood to imply the inclusion of stated elements but not the exclusion of any other elements. Terms including an ordinary number, such as first and second, are used for describing various constituent elements, but the constituent elements are not limited by the terms. The terms are only used to differentiate one component from other components.

In addition, the terms “unit,” “part” or “portion,” “-er,” and “module” in the specification refer to a unit that processes at least one function or operation, which may be implemented by hardware, software, or a combination of hardware and software.

When a component, device, element, or the like of the present disclosure is described as having a purpose or performing an operation, function, or the like, the component, device, or element should be considered herein as being “configured to” meet that purpose or perform that operation or function.

Hereinafter, embodiments of the present disclosure will be described with reference to the drawings.

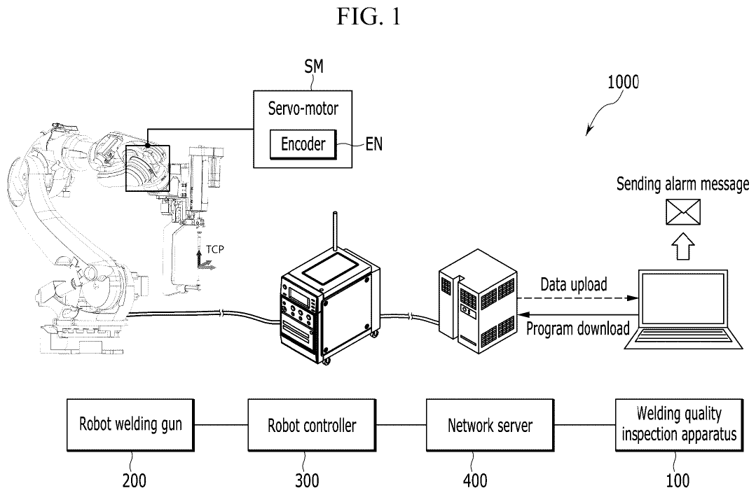

FIG. 1 is a drawing showing a welding quality inspection system according to an embodiment. A welding quality inspection system 1000 is configured to prevent defects and omissions of welding positions by using big data of welding position coordinates of a robot welding gun.

Referring to FIG. 1, the welding quality inspection system 1000 includes a welding quality inspection apparatus 100, a robot welding gun 200, a robot controller 300, and a network server 400.

The welding quality inspection apparatus 100 may be a computing device connected to the robot welding gun 200 through a network. The welding quality inspection apparatus 100 may inspect data differences between the actual welding position and a drawing by using big data of actual welding position coordinates of the robot welding gun 200. In an embodiment, the welding quality inspection apparatus 100 may implement a coordinate of the actual welding position and a coordinate of a virtual welding position of the robot welding gun 200 in the same way. The welding quality inspection apparatus 100 may autonomously compensate defects of welding positions such that the actual welding position matches the 3-dimensional data of the drawing. The welding quality inspection apparatus 100 may monitor and manage the history of positions/omissions/defects of welding points in real-time. For example, the welding quality inspection apparatus 100 compares the 3-dimensional data of the drawing and an actual welding position data of the welding gun in real-time and sends an alarm message on the defects. As a result, the welding quality inspection apparatus prevents defective vehicles from being transferred to subsequent processes.

The robot welding gun 200 may be included in a welding robot. The robot welding gun 200 includes a tool center point (TCP), and is a part in the configuration of the welding robot that provides welding position coordinates. The welding robot includes a plurality of axes. Each axis of the welding robot is moved by a servo-motor SM. An encoder EN is attached to the servo-motor SM. Position data of the servomotor SM may be checked through the encoder EN, and the corresponding information may be checked/controlled through the robot controller 300. The TCP of the robot welding gun 200 determines the actual welding position with the coordinates of the center of the robot welding gun 200. The TCP may be converted into an XYZ coordinate system format through kinematics based on information about the 6 axes of the welding robot.

The robot welding gun 200 may upload data such as welding position coordinates to the welding quality inspection apparatus 100 through the network server 400. Additionally, the robot welding gun 200 may download a welding position autonomous compensation program from the welding quality inspection apparatus 100.

The robot controller 300 may provide and control information on the welding robot including the robot welding gun 200 and axes. The network server 400 may provide a network connecting the robot welding gun 200 and the welding quality inspection apparatus 100.

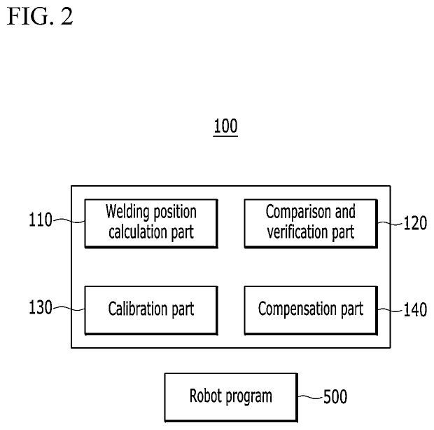

FIG. 2 is a block diagram of a welding quality inspection apparatus 100 according to an embodiment.

Referring to FIG. 2, the welding quality inspection apparatus 100 may include a welding position calculation part 110, a comparison and verification part 120, a calibration part 130, and a compensation part 140.

The welding quality inspection apparatus 100 may receive big data of actual coordinates of a robot welding gun 200 via the TCP, and may compare and verify a reference welding position of a drawing and the actual welding position of the robot welding gun. The welding quality inspection apparatus 100 may be connected to the robot program 500 that controls the motion of the welding robot including the robot welding gun 200. The robot program 500 includes information about each axis of the welding robot. The TCP representing the actual welding position of the robot welding gun 200 may be determined by information on each axis of the welding robot. In other words, the robot program 500 may determine the actual welding position of the robot welding gun 200. In the present disclosure, a welding point position may refer to the actual welding position.

The welding position calculation part 110 may receive information on the actual welding position from the robot program 500. The welding position calculation part 110 may calculate a first virtual welding position based on the received actual welding position. The first virtual welding position is a data calculated within the computing device of the welding quality inspection apparatus 100 based on the actual welding position. For example, the welding position calculation part 110 may convert each axis value included in the robot program 500 and calculate the first virtual welding position.

The first virtual welding position reflects the actual welding position and may not appear exactly the same as the actual welding position due to minor errors caused by the mechanical operation (e.g., driving) of the welding robot. In other words, when the actual welding position of the robot welding gun is uploaded to a virtual space program of the welding quality inspection apparatus 100, data that exactly matches is not uploaded and an error may occur. For example, errors may occur due to aging and/or mechanical defects of the welding robot, or the like. In addition, the actual welding position may not match the reference welding position of the drawing including the theoretical value, and may have a certain level of error.

The welding quality inspection apparatus 100 may modify the uploaded virtual welding position to match the actual welding position. The welding quality inspection apparatus 100 may also perform compensation for matching the matched virtual welding position with the reference welding position of the drawing, through which the welding quality may be inspected and improved.

The comparison and verification part 120 detects an error by comparing the actual welding position through the big data of actual coordinates of the robot welding gun with the reference welding position, which is a theoretical value extracted from the drawing. The comparison and verification part 120 may calculate a first error by comparing the first virtual welding with the reference welding position shown in the drawing. The first virtual welding position is obtained by uploading the actual welding position through the big data of coordinates. The comparison and verification part 120 may determine that inspection is necessary when a magnitude of the first error is within a predetermined reference range. In addition, the comparison and verification part 120 may determine the first virtual welding position to be normal when the magnitude of the first error is smaller than the reference range. The comparison and verification part 120 may also determine the first virtual welding position to be defective when the magnitude of the first error is greater than the reference range. The comparison and verification part 120 may exclude the first virtual welding position determined to be defective, from calibration, and then immediately provide it to the compensation part 140, for compensation.

In an embodiment, the welding quality inspection apparatus 100 may perform virtual calibration to compensate the error. The data whose reliability is secured by the calibration may correctly upload the actual welding position to the first virtual welding position, and based on this, the welding quality inspection apparatus 100 may compare the reference welding position of the drawing and the actual welding position. An embodiment of the present disclosure performs the virtual calibration in which a mathematical formula is solved by minimizing time and cost.

The calibration part 130 may perform the virtual calibration to match the first virtual welding position with the actual welding position. In an embodiment, the calibration part 130 may perform the calibration when a ratio of determining, by the comparison and verification part 120, that inspection is necessary according to the magnitude of the first error is greater than or equal to a preset criterion. The calibration part 130 may repeatedly perform the calibration until the ratio of determining that inspection is necessary becomes smaller than the preset criterion. The calibration part 130 may generate a second virtual welding position based on the first virtual welding position. Specifically, when the ratio of determining that inspection is necessary becomes smaller than the preset criterion according to the repeated calibration with respect to the first virtual welding position, the calibration part 130 may finish the calibration and define the finally generated virtual welding position as the second virtual welding position. In other words, the second virtual welding position may be data uploaded to match the actual welding position by securing reliability according to the calibration.

When the calibration is completed, the compensation part 140 may extract a second error between the second virtual welding position and the reference welding position of the drawing, and compensate the second error when the extracted second error is a predetermined reference value or more. The reference welding position, the first virtual welding position, and the second virtual welding position may be calculated as 3-dimensional coordinates.

In an embodiment, the compensation part 140 may compare the actual welding position and the reference welding position, which is the coordinates of the welding point indicated in the drawing, through the second virtual welding position. The compensation part 140 may also determine whether to modify, and send an alarm message.

For example, when the welding point or welding position is to be modified, the compensation part 140 may notify the reason for the modification of a corresponding welding point and calculate a coordinate system modification value based on the comparison with the drawing. The compensation part 140 may modify the robot program by using the calculated error value in the x, y, z coordinates, and autonomously compensate the position of the robot welding gun through the network server connected to the robot controller. The compensation part 140 may consequently match the welding point position with the drawing. In an embodiment, the compensation part 140 may compensate the first virtual welding position determined to be defective by the comparison and verification part 120 to match the reference welding position. In other words, the first virtual welding position determined to be defective may be immediately compensated by the compensation part 140 without going through the calibration.

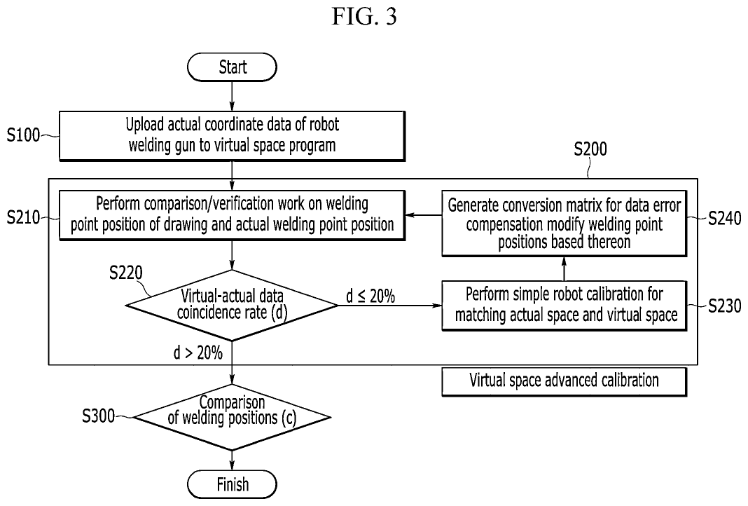

FIG. 3 is a flowchart of a welding quality inspection method according to an embodiment.

In FIG. 3, at step S100, the welding quality inspection apparatus 100 may upload the coordinates of the actual welding position of the robot welding gun to the virtual space program of the welding quality inspection apparatus 100. Furthermore, at step S100, the welding quality inspection apparatus 100 may calculate the first virtual welding position. The virtual space program may correspond to a simulation in the computing server of the welding quality inspection apparatus 100.

At step S200, the welding quality inspection apparatus 100 may perform the virtual calibration with respect to the first virtual welding position uploaded in the virtual space program, and match the actual welding position and the first virtual welding position.

In more detail, at step S210, the welding quality inspection apparatus 100 may compare and verify the welding point position of the drawing and the welding point position of the actual robot gun.

At step S220, the welding quality inspection apparatus 100 may determine a coincidence rate “d” of the first virtual welding position and the actual welding position. In an embodiment, the welding quality inspection apparatus 100 may calculate an error by comparing the first virtual welding position and the reference welding position of the drawing. The welding quality inspection apparatus 100 may also perform the calibration when the ratio of welding points of which the calculated error is in a range of 5 mm to 10 mm is 80% or more of the total cases. In other words, the calibration may be performed when the coincidence rate “d” of the first virtual welding positions and the reference welding positions is 20% or less.

At step S230, the welding quality inspection apparatus 100 may perform a simple robot calibration for matching an actual space and a virtual space. The matching of the actual space and the virtual space may be matching between an actual welding point position and a virtual welding point position uploaded to the simulation. The simple robot calibration is a virtual calibration, and may be referred to as an advanced calibration.

The welding quality inspection apparatus 100 may perform comparison and verification on the first virtual welding position modified through the calibration with respect to the reference welding position. The welding quality inspection apparatus 100 may also check again whether the welding positions whose error are in a range of 5 mm to 10 mm is 80% or more of the entire welding positions. When the cases in which the error of the modified first virtual welding position is in a range of 5 mm to 10 mm still exceeds 80%, the welding quality inspection apparatus 100 may perform the calibration again. When the ratio of welding points of which the error of the first virtual welding position, finally modified after the repeated calibration is in a range of 5 mm to 10 mm, is less than 80%, the welding quality inspection apparatus 100 may discontinue further calibration.

For example, when one welding robot is supposed to weld 20 points, i.e., welding positions, according to the equipment on the welding robot and the quality level of the robot and the component part, the difference within 5 mm between the reference welding position of the drawing and the actual welding position may be determined to be normal (e.g., acceptable) by the welding quality inspection apparatus 100. For a position difference between 5 mm to 10 mm, the welding quality inspection apparatus 100 may check whether the actual welding position matches the virtual welding position, and may perform modification of the welding position through calibration. For example, when 80% or more of these 20 welding positions are out of the reference welding positions, within the 5 mm to 10 mm range, it may be determined that the calibration of the welding robot is defective. In this case, the welding quality inspection apparatus 100 may perform the virtual calibration (advanced calibration). In this case, the welding quality inspection apparatus 100 performs modification to match the first virtual welding position with the reference welding position through the virtual calibration.

For welding positions having differences of 10 mm or more, the welding quality inspection apparatus 100 excludes them from the virtual calibration. However, the welding quality inspection apparatus 100 may perform compensation of the welding positions of such welding points in the future.

At step S240, the welding quality inspection apparatus 100 may generate a conversion matrix for data error compensation and modify welding point positions by using the same.

In an embodiment, different from a conventional calibration, the virtual calibration of the present disclosure does not require measurement equipment. The actual space coordinate and the virtual space coordinate may be matched by using 3-dimensional position information data on the drawing and the big data information of the actual welding positions of the welding gun.

The welding quality inspection apparatus 100 may compare all welding point position data of the robot welding gun with drawing welding point position data and calculate the difference in values.

The value obtained by inversely calculating the difference between the first virtual welding position implemented in the virtual space of the welding quality inspection apparatus 100 based on the actual welding position and the reference welding position of the drawing is called the conversion matrix. The welding quality inspection apparatus 100 may select the conversion matrix of position data of each welding point possessed by the welding robot as one model through optimization modeling, and may determine this as a final conversion matrix of one welding robot. Since it is a method of setting a standard value, when the actual welding position and the 3-dimensional virtual welding position of the drawing of the robot welding gun deviate by 10 mm or more, the welding quality inspection apparatus 100 may select it to be defective and exclude it from the conversion matrix. The welding quality inspection apparatus 100 may compensate the position and coordinate value of each welding point through calibration in the virtual space program by using the final conversion matrix and then may perform the comparison and verification of the welding point again. When welding positions of 80% or more still deviate from the reference welding position by 5 mm to 10 mm after repeating the performing of the comparison and verification, the welding quality inspection apparatus 100 may repeatedly perform the virtual calibration work by using the compensated result value. As a result, the process increases the precision of the calibration, to match the actual welding position of the welding gun of the actual space and the virtual position data of the welding gun of the virtual space.

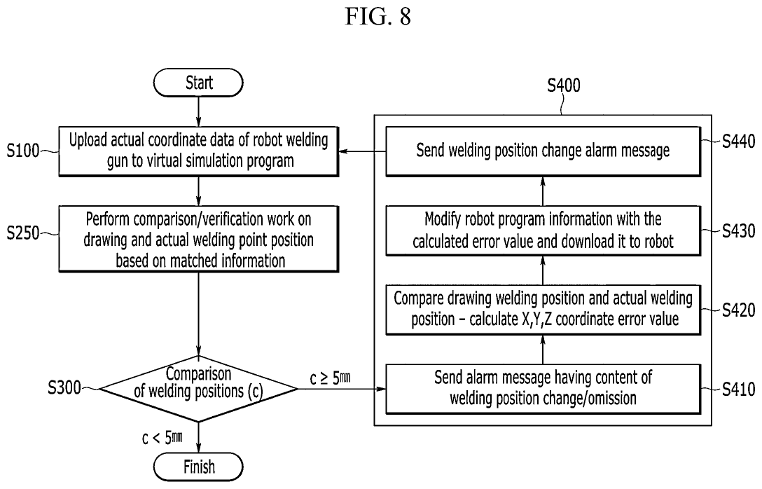

At step S300, the welding quality inspection apparatus 100 may compare the second virtual welding position generated through the calibration with the reference welding position, and determine whether to compensate the welding position. This will be explained in detail with reference to FIG. 8.

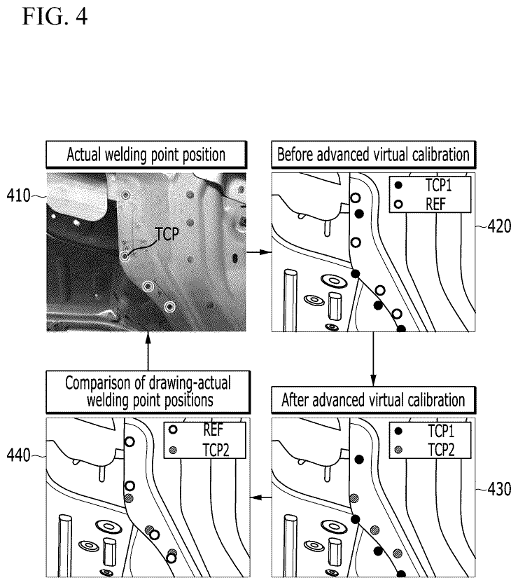

FIG. 4 is a drawing showing a calibration step according to an embodiment.

In FIG. 4, the actual welding position TCP corresponds to the actual welding point that is a spot on which the real robot welding gun actually performs welding. The actual welding point may be confirmed by a photo 410 showing the actual welding point position. In the photo 410 showing the actual welding point positions, actual welding position TCPs of four welding points are shown as an example.

In a drawing 420 before the advanced virtual calibration, it may be seen that the first virtual welding position is uploaded based on the actual welding position TCP, and mapped on the drawing. In the drawing 420 before the advanced virtual calibration, it may be seen that the reference welding position REF and the first virtual welding position TCP1 are spaced apart from each other with the first error. In the drawing 420 before the advanced virtual calibration, the reference welding position REF and the first virtual welding position TCP1 corresponding to four welding points existing in the photo 410 showing the actual welding point position may be confirmed.

Referring to the photo 410 showing the actual welding point position and the drawing 420 before the advanced virtual calibration, it may be seen that although the first virtual welding position TCP1 was uploaded based on the actual welding position TCP, there is an error between the actual welding position TCP and the first virtual welding position TCP1.

A drawing 430 after the advanced virtual calibration shows the first virtual welding position TCP1 and the second virtual welding position TCP2. The second virtual welding position TCP2 corresponds to data obtained after repeatedly performing the virtual calibration (or the advanced virtual calibration) based on the first virtual welding position TC1.

In the drawing 430 after the advanced virtual calibration, the second virtual welding position TCP2 is disposed at a position modified from the first virtual welding position TCP1 according to the calibration. The second virtual welding position TCP2 is compared with the first virtual welding position TCP1, to reflect the actual welding position TCP more precisely.

A drawing 440 of the comparison of the drawing—the actual welding point positions shows the reference welding position of the drawing REF and the second virtual welding position TCP2 generated according to the calibration.

In the drawing 440 of the comparison of the drawing—the actual welding point positions, the reference welding position of the drawing REF and the second virtual welding position TCP2 are disposed apart from each other with the second error. It may be seen that the second virtual welding position TCP2 is disposed closer to the reference welding position REF, in comparison with the first virtual welding position TCP1 of the drawing 420 before the advanced virtual calibration. In other words, the second error may be smaller on average than the first error.

When comparing the drawing 440 of the comparison of the drawing—the actual welding point positions and the photo 410 showing the actual welding point position, it may be seen that the second virtual welding position TCP2 generated according to the calibration matches the actual welding position TCP.

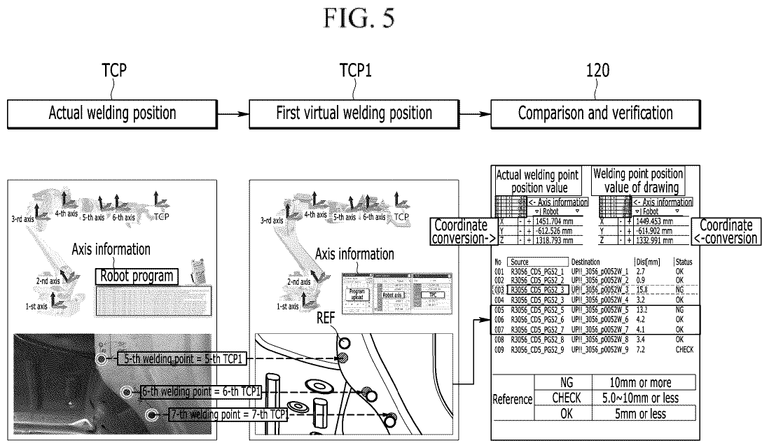

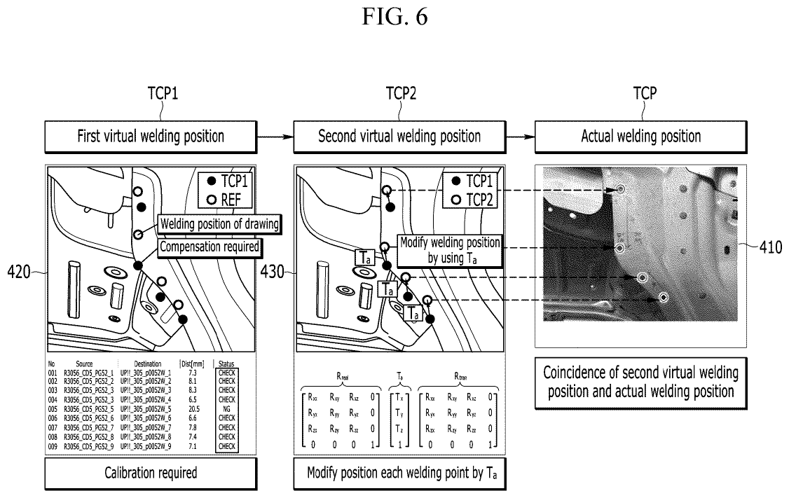

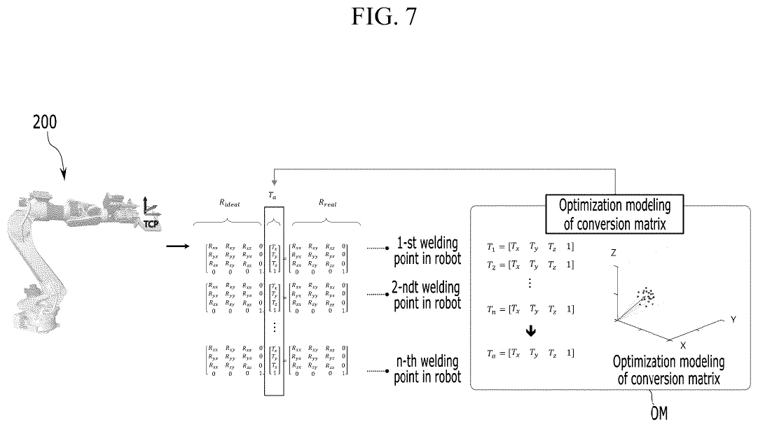

FIG. 5 is a drawing showing a comparison and verification step according to an embodiment. FIG. 6 is a drawing showing a calibration step according to an embodiment. FIG. 7 shows the conversion matrix according to an embodiment.

FIG. 5 shows the comparison and verification step before the calibration step in FIG. 4 in detail. In FIG. 5, the actual welding position TCP may be calculated based on the plurality of axes (e.g., 1-st axis to 6-th axis) of the welding robot. The actual welding position TCP may be generated through a robot program including the axis information. Generally, one welding robot performs welding of a plurality of welding points. For example, the actual welding position TCP may be generated for a 5-th welding point, a 6-th welding point, and a 7-th welding point, respectively.

The first virtual welding position TCP1 may be generated as a result of uploading the information on the actual welding position TCP generated through the robot program to the simulation. The first virtual welding position may be shown on the drawing and include coordinates. For example, the first virtual welding positions TCP1 of the 5-th welding point, the 6-th welding point, and the 7-th welding point may correspond to the actual welding positions TCP of the 5-th welding point, the 6-th welding point, and the 7-th welding point, respectively. The first virtual welding position TCP1 may not match the reference welding position REF, which is a theoretical value shown on the drawing, but may be apart therefrom with the first error.

The comparison and verification part 120 may compare and verify the actual welding position TCP, which is the actual welding point position value, and the reference welding position of the drawing REF. In order to determine whether to compensate the welding position, the comparison and verification part 120 calculates an error between the actual welding position TCP and the reference welding position of the drawing REF. Since the actual welding position TCP is an actual value, the comparison and verification part 120 may compare and verify the first virtual welding position TCP1 mapped on the drawing based on this with the reference welding position REF.

The comparison and verification part 120 may calculate coordinate values by converting coordinates of the information on the actual welding position including axis information and information on the reference welding position of the drawing. The comparison and verification part 120 may calculate an error by comparing the calculated coordinate value. In an embodiment, the comparison and verification part 120 may, when the first error between the calculated first virtual welding position TCP1 and the reference welding position REF is 5 mm or less, determine it to be normal (OK), determine that an inspection (CHECK) is required when it is between 5 mm to 10 mm, and determine it to be defective (NG) when it is 10 mm or more.

In FIG. 5, for example, it may be seen that the error between the reference welding position REF and the first virtual welding position TCP1 of the 5-th welding point is 13.2 and determined to be defective. It may also be seen that the error between the reference welding position REF and the first virtual welding position TCP1 of the 6-th welding point is 4.2 and determined to be normal. Additionally, it may be seen that the error between the reference welding position REF and the first virtual welding position TCP1 of the 7-th welding point is 4.1 and determined to be normal.

FIG. 6 shows in detail the calibration step after the comparison verification step in FIG. 5. The following description will be made with reference to the photo 410 showing the actual welding point position of FIG. 4, the drawing 420 before the advanced virtual calibration, and the drawing 430 after the advanced virtual calibration.

In FIG. 6, in the drawing 420 before the advanced virtual calibration, the first virtual welding position TCP1 is spaced apart from the reference welding position REF with the first error. In a table showing the error between the reference welding position REF and each of the first virtual welding positions TCP1 of from the 1-st welding point to the 9-th welding point, it may be seen that, it is determined that the inspection is required (CHECK) when the error is 5 mm to 10 mm, and it is determined to be defective (NG) when the error exceeds 10 mm. For example, in the case of the 5-th welding point, the error corresponds to 20.5 mm and is determined to be defective (NG), such that it may be necessary to be excluded from calibration, and immediately compensated through the compensation part 140 (refer to FIG. 2). Since the error of each of 1-st to 4-th welding points and 6-th to 9-th welding points excluding the 5-th welding point appears to be in the reference range of 5 mm to 10 mm, it is determined that inspection is required (CHECK).

Therefore, the ratio of welding points determined that inspection is required (CHECK) exceeds 80% of the entire welding points, the welding quality inspection apparatus 100 may determine that the virtual (advanced) calibration is required.

Referring to the drawing 430 after the advanced virtual calibration, the welding quality inspection apparatus 100 may perform the virtual calibration by using the conversion matrix Ta based on a coordinate (Rreal) of the first virtual welding position TCP1, and may generate a coordinate (Rtran) of the second virtual welding position TCP2.

When the second virtual welding position TCP2 of the drawing 430 after the advanced virtual calibration is compared with the actual welding position TCP of the photo 410 showing the actual welding point position, it may be seen that they match (i.e., coincide with) each other.

FIG. 7 shows generating a transformation matrix used in the performing calibration of FIG. 6.

In FIG. 7, the 3-dimensional coordinate matrix R_real of the actual welding point corresponds to the coordinate of the actual welding position value of the robot welding gun. The coordinate matrix R_ideal of the welding point of the drawing corresponds to the coordinate value of the reference welding position of the drawing in the 3-dimensional virtual space. The coordinate matrix R_ideal of the welding point of the drawing is a value obtained by moving the position of the welding gun of the robot to the reference welding position of the drawing in the virtual space, and calculating the position data of the welding gun in a predetermined coordinate system. The conversion matrix Ta is a value obtained by comparing the actual welding position of the actual welding point and the reference welding position of the welding point on the drawing, and may be expressed as a vector. In an embodiment, the welding quality inspection apparatus 100 may compare n (e.g., twenty) welding points per each welding robot, extract each of the conversion matrices T1 to Tn, and then calculate a conversion vector Ta (T_average) through optimization modeling OM.

FIG. 8 is a flowchart of a welding quality inspection method according to an embodiment.

In FIG. 8, at step S100, the welding quality inspection apparatus 100 may upload the data of actual coordinates of the robot welding gun to the virtual simulation program. Thereafter, the welding quality inspection apparatus 100 may match the actual welding position and the virtual welding position through the virtual calibration. For the virtual calibration step S200, the description made with reference to FIG. 3 may be referred to.

At step S250, the welding quality inspection apparatus 100 may perform a comparison and verification of the positions of the drawing and the actual welding point based on the information of the matched welding position. In other words, the welding quality inspection apparatus 100 may compare and verify the second virtual welding position mapped on the drawing matching the actual welding point with the theoretical value of the reference welding position of the drawing.

The welding quality inspection apparatus 100 compares the reference welding position of the drawing and the actual welding position, and when modification of the actual welding position is required, the welding quality inspection apparatus 100 may perform step S400. At step S400, the welding quality inspection apparatus 100 may perform position compensation of the welding point, where the welding quality inspection apparatus 100 may notify a reason for the modification of a corresponding welding position, compare it with the reference welding position of the drawing, and calculate a modification value of a coordinate system of the welding point.

For example, the welding quality inspection apparatus 100 may, when the error “c” of the actual welding position and the reference welding position of the drawing is the reference value of 5 mm or greater, determine that a position modification of the welding point is required. Furthermore, when the reference value is less than 5 mm, the welding quality inspection apparatus 100 may determine that the position modification of the welding point is not required.

At step S410, when it is determined that the position modification of the welding point is required, the welding quality inspection apparatus 100 may send a first alarm message having information regarding the change of the welding point position and potential omission of the welding point position.

At step S420, the welding quality inspection apparatus 100 may compare the reference welding position of the drawing and the actual welding position of the actual welding point and calculate the error in 3-dimensional coordinates.

At step S430, the welding quality inspection apparatus 100 may modify data in the robot program 500 (refer to FIG. 2) with the calculated error such that the welding robot may download it.

At step S440, when the position modification of welding point is completed, the welding quality inspection apparatus 100 may send a second alarm message regarding the position change of the welding point (step S440).

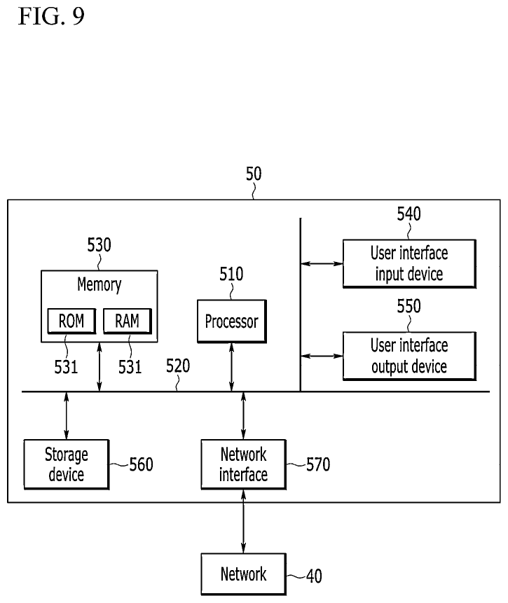

FIG. 9 is a drawing for explaining a computing device according to an embodiment.

Referring to FIG. 9, a welding quality inspection apparatus and method according to an embodiment may be implemented by using a computing device 50.

The computing device 50 may include at least one of a processor 510, a memory 530, a user interface input device 540, a user interface output device 550, and a storage device 560, that communicate through a bus 520. The computing device 50 may also include a network interface 570 electrically connected to a network 40. The network interface 570 may transmit or receive signals with other entities through the network 40.

The processor 510 may be implemented in various types such as a micro controller unit (MCU), an application processor (AP), a central processing unit (CPU), a graphic processing unit (GPU), a neural processing unit (NPU), and the like. Additionally, the processor 510 may be any type of semiconductor device capable of executing instructions stored in the memory 530 or the storage device 560. The processor 510 may be configured to implement the functions and methods described above with respect to FIGS. 1-8.

The memory 530 and the storage device 560 may include various types of volatile or non-volatile storage media. For example, the memory may include read-only memory (ROM) 531 and a random-access memory (RAM) 532. In this embodiment, the memory 530 may be located inside or outside the processor 510, and the memory 530 may be connected to the processor 510 through various known means.

In some embodiments, at least some configurations or functions of a welding quality inspection apparatus and method according to an embodiment may be implemented as a program or software executable by the computing device 50. Additionally, the program or software may be stored in a computer-readable medium.

In some embodiments, at least some configurations or functions of a welding quality inspection apparatus and method according to an embodiment may be implemented by using hardware or circuitry of the computing device 50. In other embodiments, at least some configurations or functions of a welding quality inspection apparatus and method according to an embodiment may also be implemented as separate hardware or circuitry that may be electrically connected to the computing device 50.

Although the embodiments of the present disclosure have been described in detail above, the scope of the present disclosure is not limited thereto. Various modifications and improvements made by those having ordinary skill in the art also fall within the scope of the present disclosure.

### DESCRIPTION OF SYMBOLS

100: welding quality inspection apparatus
110: welding position calculation part
120: comparison and verification part
130: calibration part
140: compensation part
200: the robot welding gun
300: robot controller
400: network server
500: robot program

What is claimed is:

1. A welding quality inspection apparatus, comprising:
a welding position calculation part configured to calculate a first virtual welding position based on an actual welding position of a robot welding gun;
a comparison and verification part configured to:
calculate a first error by comparing the first virtual welding position and a reference welding position of a drawing, and
determine that inspection is necessary when a magnitude of the first error is within a reference range;
a calibration part configured to, when a ratio of determining that inspection is necessary, by the comparison and verification part, is a preset criterion or more, generate a second virtual welding position based on the first virtual welding position by repeating calibration until the ratio of determining that inspection is necessary becomes less than the preset criterion; and
a compensation part configured to extract a second error between the second virtual welding position and the reference welding position when the calibration is finished, and to compensate the second error when the second error is a predetermined reference value or more.

2. The welding quality inspection apparatus of claim 1, wherein the reference welding position, the first virtual welding position, and the second virtual welding position are calculated as 3-dimensional coordinates.

3. The welding quality inspection apparatus of claim 2, wherein the calibration part is configured to perform calibration in which a conversion matrix for compensation of the first error is generated, and wherein the first virtual welding position is compensated by using the conversion matrix.

4. The welding quality inspection apparatus of claim 3, wherein the conversion matrix is calculated by comparing the first virtual welding position and the reference welding position, and wherein the first virtual welding position and the reference welding position are expressed as vectors.

5. The welding quality inspection apparatus of claim 1, wherein the comparison and verification part is configured to:
determine the first virtual welding position to be normal when the magnitude of the first error is smaller than the reference range, and
determine the first virtual welding position to be defective when the magnitude of the first error is greater than the reference range.

6. The welding quality inspection apparatus of claim 5, wherein the compensation part compensates the first virtual welding position determined to be defective to match the reference welding position.

7. The welding quality inspection apparatus of claim 1, wherein the reference range is 5 mm to 10 mm.

8. The welding quality inspection apparatus of claim 1, wherein the preset criterion is 80%.

9. The welding quality inspection apparatus of claim 1, wherein the predetermined reference value is 5 mm.

10. The welding quality inspection apparatus of claim 2, wherein the compensation part is configured to:
extract the 3-dimensional coordinates of each of the second virtual welding position and the reference welding position to calculate the second error, and
modify a robot program of the robot welding gun with the second error to compensate the actual welding position of the robot welding gun.

11. The welding quality inspection apparatus of claim 10, wherein the compensation part is configured to:
send a first alarm message regarding a welding position's defects when the compensation is determined to be required, and
send a second alarm message notifying that the welding position has been changed when the compensation is completed.

12. A welding quality inspection method, comprising:
calculating, by a welding quality inspection apparatus, a first virtual welding position by uploading a coordinate of a robot welding gun with respect to an actual welding position to the welding quality inspection apparatus;
performing comparison and verification, by the welding quality inspection apparatus, wherein a first error is calculated by comparing the first virtual welding position and a reference welding position of a drawing, and determining that inspection is necessary when a magnitude of the first error is within a reference range;
performing calibration; and
when a ratio of determining that inspection is necessary is a preset criterion or more, generating a second virtual welding position based on the first virtual welding position that is generated by repeating calibration until the ratio of determining that inspection is necessary becomes less than the preset criterion.

13. The welding quality inspection method of claim 12, wherein performing calibration comprises:
generating a conversion matrix for compensation of the first error; and
compensating the first virtual welding position by using the conversion matrix.

14. The welding quality inspection method of claim 13, wherein the conversion matrix is calculated by comparing 3-dimensional coordinate values of the first virtual welding position and the reference welding position.

15. The welding quality inspection method of claim 12, further comprising:
extracting a second error between the second virtual welding position and the reference welding position when the calibration is finished; and
compensating the second error when the second error is a predetermined reference value or more.

16. The welding quality inspection method of claim 15, wherein performing comparison and verification comprises:
determining the first virtual welding position to be normal when the magnitude of the first error is smaller than the reference range; and
determining the first virtual welding position to be defective when the magnitude of the first error is greater than the reference range.

17. The welding quality inspection method of claim 16, wherein compensating the second error comprises:
compensating the first virtual welding position determined to be defective, to match the reference welding position.

18. The welding quality inspection method of claim 15, wherein compensating the second error further comprises:
extracting the coordinate of each of the second virtual welding position and the reference welding position, to calculate the second error; and
modifying a robot program of the robot welding gun with the second error, to compensate the actual welding position of the robot welding gun.

19. The welding quality inspection method of claim 12, wherein the reference range is 5 mm to 10 mm.

20. The welding quality inspection method of claim 12, wherein the preset criterion is 80%.
